(19) United States
(12) Patent Application Publication
(10) Pub. No.: US 2023/0368987 A1
(43) Pub. Date: Nov. 16, 2023

(54) DC DISCONNECTOR

(71) Applicant: G Corner Electrical Systems Limited, Bolton (GB)

(72) Inventors: Stephen Hibberson, Bolton (GB); Michael Saunders, Bolton (GB); Christopher Hall, Bolton (GB)

(21) Appl. No.: 18/142,811

(22) Filed: May 3, 2023

(30) Foreign Application Priority Data
May 13, 2022 (GB) 2206992.6

(51) Int. Cl. H01H 3/32; H01H 1/14

(52) U.S. Cl. CPC H01H 3/32; H01H 1/14

(57) ABSTRACT

A DC disconnector comprising a static electrical contact, at least one moveable electrical contact comprising a plurality of conductor blades, and a shaft, coupled to the movable electrical contact. The shaft is configured to actuate the moveable electrical contact between a first configuration and a second configuration, wherein at least a portion of each conductor blade abuts the static electrical contact in the first configuration, and wherein the plurality of conductor blades are displaced from the static electrical contact in the second configuration. The Disconnector further comprises at least one of a plurality of features, including (i) wherein the static electrical contact comprises plurality of contact elements; (ii) wherein the shaft is coupled to the moveable electrical contact by an eccentric component; (iii) wherein the moveable electrical contact comprises a plurality of spacers arranged in between the conductor blades; (iv) wherein the position of the shaft axis is adjustable; and (v) wherein the conductor blades are configured to be removable from the Disconnector.

### FIELD OF THE INVENTION

The present invention relates to a DC disconnector.

### BACKGROUND

Disconnectors are used in high current applications to provide fail-safe disconnection (off-loading) and isolation of supply. Commonly disconnectors are welded into aluminium busbar systems. Disconnectors can also be used as an interchange from an aluminium busbar to a copper busbar, for example whereby one side is welded into aluminium and the other side is screwed into a copper busbar.

Disconnectors are also known to deform, for example wherein the disconnector is capable of deformability of up to ±30 mm in any plane.

The conducting blades and/or electrical contacts can also corrode due to environmental conditions causing the disconnector to perish.

The contacts on the static electrical contact can also corrode which requires difficult and expensive servicing, replacement, and maintenance.

### SUMMARY OF THE INVENTION

Aspects of the disclosure are as set out in the independent claims and optional features are set out in the dependent claims. Aspects of the invention may be provided in conjunction with each other and features of one aspect may be applied to other aspects.

In a first aspect there is provided a DC disconnector comprising a static electrical contact and at least one moveable electrical contact. The static electrical contact comprises a plurality of contact elements, wherein each contact element is configured to be individually and reversibly coupled to the static electrical contact. The moveable electrical contact comprises a plurality of conductor blades and is coupled to a shaft, wherein the shaft is configured to actuate the moveable electrical contact between a first configuration and a second configuration. In the first configuration, at least a portion of each of the plurality of conductor blades is configured to abut at least one contact element. In the second configuration, the plurality of conductor blades are displaced from the contact elements of the static electrical contact.

The plurality of contact elements may be advantageous for easy replacement and/or maintenance compared to existing DC disconnectors which comprise a single electrical contact. In this example, a single contact element, or a portion of contact elements, may be individually replaced, for example if corroded, rather than having to replace the electrical contact for the entire disconnector; thus, reducing repair and maintenance time, cost and materials used.

In some examples, at least a portion of each contact element may be arranged in a recess of the static electrical contact. This may be advantageous for easy alignment during replacement and maintenance.

In some examples, each contact element may comprise (i) a contact engaging face configured to contact at least one conductor blade in the first configuration; and (ii) a connecting portion, for example a connecting plate, configured to couple the contact element to the static electrical contact. In some examples, each contact element may be mechanically coupled to the static electrical contact, for example by bolting.

The contact engaging face is made of an electrically conductive material. In some examples, the contact engaging face of the contact element is made of silver. In some examples the connecting portion is made of an electrically conductive material. In some examples, the connecting portion may be made of copper. This may be advantageous as copper is cheaper than silver. In some examples, the silver contact engaging face is bonded, welded, or brazed onto the connecting portion. This may be advantageous to overcome oxidation challenges and weaknesses which would otherwise result from direct silver to aluminium bonding, welding, or brazing, wherein the static electrical contact may be aluminium.

In some examples, each contact element comprises a cut-out portion, wherein the cut-out portion is configured to accommodate deformation of the contact element. This may be advantageous to reduce warping of the contact elements. Example types of deformation may include, but are not limited to, thermal expansion and contraction, deformation, and movement. In some examples, the connecting plate comprises the cut-out portion. In some examples, the cut-out portion comprises a slot.

In some examples, the plurality of contact elements are spaced along at least one edge of the static electrical contact.

In some examples, the at least one moveable electrical contact comprises two moveable contacts. In some examples, the two moveable contacts are arranged on opposite sides of the static electrical contact. In some examples, the plurality of contact elements are spaced along two opposite edges of the static electrical contact, such that at least a portion of each of the plurality of conductor blades from the first and second moveable electrical contacts is configured to abut at least one contact element in the first configuration.

In a second aspect of the invention, there is provided, a DC disconnector comprising a static electrical contact, at least one moveable electrical contact, comprising a plurality of conductor blades; and a shaft, coupled to the at least one movable electrical contact, wherein the shaft is configured to actuate the moveable electrical contact between a first configuration and a second configuration. In the first configuration, at least a portion of each of the plurality of conductor blades are configured to abut the static electrical contact. In the second configuration, the plurality of conductor blades are displaced from the static electrical contact. The moveable electrical contact is coupled to the shaft via an eccentric component, wherein the eccentric component is configured to adjust the contact pressure of at least a portion of the plurality of conductor blades abutting the static electrical contact in the first configuration.

The contact pressure may be configured to be adjusted by rotating the eccentric component. The rotated position of the eccentric component may be configured to be adjustably secured such that the adjusted contact pressure may be maintained.

The eccentric component may be configured to alter the contact pressure by altering the distance between the plurality of conductor blades and the static electrical contact. In some examples, the distance may be altered by, for example, but not limited to, approximately +/−5 mm. The maximum alteration distance may be dependent on the size of the eccentric component.

In some examples, the moveable electrical contact is coupled to the shaft via at least one actuator arm, wherein the actuator arm is configured to actuate the moveable electrical contact between the first configuration and the second configuration by applying a vertical force component and a horizontal force component to the moveable electrical contact during rotation of the shaft. In such examples, the actuator arm is coupled to the plurality of conductor blades via the eccentric component.

In some examples, the at least one moveable electrical contact comprises two moveable contacts. In some examples, the two moveable contacts are arranged on opposite sides of the static electrical contact.

In a third aspect there is provided a DC disconnector comprising a static electrical contact, at least one a moveable electrical contact, and a shaft, coupled to the at least one movable electrical contact, wherein the shaft is configured to actuate the at least one moveable electrical contact between a first configuration and a second configuration. Each moveable electrical contact comprises a plurality of adjacent conductor blades. In the first configuration, at least a portion of each conductor blade is configured to abut the static electrical contact. In the second configuration, the moveable electrical contact is displaced from the static electrical contact. Each moveable electrical contact further comprises a plurality of spacers, wherein the plurality of spacers are configured to align the plurality of conductor blades in a parallel configuration. This may be advantageous to prevent misalignment of the conductor blades.

In some examples, each of the plurality of spacers is arranged in between a pair of adjacent conductor blades, configured to align the pair of conductor blades in a parallel configuration. In some examples, each spacer is configured to couple said corresponding pair of adjacent conductor blades together. In some examples, a spacer is arranged in between alternating pairs of adjacent conductor blades with the moveable electrical contact.

In some examples, each spacer comprises a spacer head, wherein the spacer head is configured to be arranged in between the pair of adjacent conductor blades, and wherein the spacer head has the same width as the spacing between the pair of adjacent conductor blades. In some examples, each spacer further comprises a coupling means, wherein the coupling means is configured to couple together each of the pair of adjacent conductor blades to opposite sides of the spacer head.

In some examples, the plurality of spacers are configured to align the longitudinal axes of the plurality of conductor blades in a parallel configuration, wherein the longitudinal axes of the plurality of conductor blades are perpendicular to the rotational axis of the shaft.

In some examples, the plurality of spacers may be coupled to an actuator bar of the moveable electrical contact, such that the plurality of conductor blades are coupled to the actuator bar via the plurality of spacers. The actuator bar may be coupled to the shaft via at least one actuator arm, such that the actuator arm coupled to the actuator bar is configured to actuate the plurality of conductor blades between the first configuration and the second configuration.

In some examples, the at least one moveable electrical contact comprises two moveable contacts. In some examples, the two moveable contacts are arranged on opposite sides of the static electrical contact.

In some examples, at least a portion of the plurality of spacers may comprise a contact pressure module, wherein each contact pressure module is configured to apply a mechanical biasing pressure to at least the coupled pair of adjacent conductor blades such that the conductor blades are biased to contact the static electrical contact in the first configuration. In some examples, each spacer comprises a contact pressure module. In some examples, the contact pressure module comprises a spring. This arrangement may be advantageous compared to existing solutions wherein contact pressure modules are coupled to the edge of conductor blades, as coupling the contact pressure module in between conductor blades may prevent misalignment of the conductor blades and promote the biasing pressure being equally distributed between the conductor blades.

In some examples, each contact pressure module is configured to be adjustable such that the mechanical biasing pressure applied to the conductor blades is configured to be adjustable. For example, in examples where the contact pressure module comprises a spring, the tension and/or compression of the spring is configured to be adjustable, such that the biasing pressure applied by the spring to the coupled pair of adjacent conductor blades is adjustable based on the tension and/or compression of the spring. In some examples, each contact pressure module comprises a spring coupled to the actuator bar and wherein each spring is configured to engage with the actuator bar and at least one pair of adjacent conductor blades such that the tension and/or compression of each spring is configured apply the biasing pressure to at least the pair of adjacent conductor blades, and wherein the biasing pressure is configured to be adjustable by adjusting the tension and/or compression of each spring by adjusting the spacing between the actuator bar and the conductor blades. In some examples, each contact pressure module comprises a fastening means, wherein the fastening means is configured to reversibly secure the spacing between the actuator bar and the conductor blades. In some examples, the fastening means is configured to be adjusted to alter the tension and/or compression of the spring by altering the spacing between the actuator bar and the conductor blades.

In a fourth aspect of the invention, there is provided a DC disconnector comprising a static electrical contact, at least one moveable electrical contact, and a shaft, comprising an axis. The shaft is coupled to the at least one moveable electrical contact, wherein the shaft is configured to actuate the moveable electrical contact between a first configuration and a second configuration. In the first configuration, the movable electrical contact abuts the static electrical contact. In the second configuration, the moveable electrical contact is displaced from the static electrical contact. The position of the shaft axis, for example the longitudinal or rotational axis, is configured to be adjustable relative to the position of the static electrical contact, such that the position of the moveable electrical contact is configured to be adjustable relative to the position of the static electrical contact. This may be advantageous to adjust and tune the alignment of the disconnector to ensure good electrical contact between the moveable electrical contact and the static electrical contact in the first configuration.

In some examples, the moveable electrical contact is coupled to the shaft via at least one actuator arm, wherein the actuator arm is configured to actuate the moveable electrical contact between the first configuration and the second configuration by applying a vertical force component and a horizontal force component to the moveable electrical contact during rotation of the shaft. In some examples, the position of the shaft axis is configured to be adjustable such that the position of the at least one actuator arm is adjusted relative to the position of the static electrical contact. Thus, the position of the moveable electrical contact relative to the static electrical contact may be adjusted without changing the vertical and/or horizontal force component supplied to the moveable electrical contact via the actuator arm. In some examples, adjusting the position of the shaft comprises adjusting at least one of (i) the vertical position of the shaft, or (ii) the horizontal position of the shaft.

In some examples, the DC disconnector further comprises a support plate configured to support the shaft and means configured to adjust the position of the shaft axis relative to the position of the support plate, such that the position of the moveable electrical contact is adjusted relative to the position of the static electrical contact.

In some examples, the support plate comprises a slot configured to receive the shaft, wherein the position of the shaft axis within the slot is configured to be adjustable. In some examples, the longitudinal axis of the slot is aligned parallel to the static electrical contact, such that adjusting the position of the shaft axis within the slot maintains the separation distance between the shaft axis and the static electrical contact. In some examples, the position of the shaft axis may be altered by, for example, but not limited to, approximately +/−10 mm. The maximum alteration distance may be dependent on the size of the slot within the support plate.

In some examples, the at least one moveable electrical contact comprises a contact engaging face portion, configured to abut the static electrical contact in the first configuration. The position of the shaft axis may be configured to be adjustable relative to the static electrical contact such that the position of contact engaging face portion may be adjusted to align with the position of the static electrical contact, such that the contact engaging face portion abuts the static electrical contact in the first configuration.

In some examples the DC disconnector further comprises an adjustable securing means, coupled to the shaft, wherein the adjustable securing means is configured to adjustably engage with at least a portion of the support plate such that the position of the shaft axis is reversibly secured to maintain the position of the moveable electrical contact relative to the position of the static electrical contact, for example reversibly securing the position of the shaft axis within the slot of the support plate. In some examples, adjustably engaging with at least a portion of the support plate may comprise applying a force to the support plate such that the support plate is engaged to maintain the position of the moveable electrical contact relative to the position of the static electrical contact. In some examples, the adjustable securing means comprises at least one pressure screw configured to apply a point force to the support plate such that the adjustable securing means is engaged to maintain the position of the shaft axis, and therefore maintain the position of the moveable electrical contact relative to the position of the static electrical contact.

In a fifth aspect there is provided a DC disconnector comprising a static electrical contact, at least one moveable electrical contact comprising a plurality of conductor blades, and a shaft. The shaft is coupled to the moveable electrical contact via an actuator arm, wherein the shaft is configured to actuate the actuator arm to actuate the moveable electrical contact between a first configuration and a second configuration. In the first configuration, at least a portion of the plurality of conductor blades abut the static electrical contact. In the second configuration, the plurality of conductor blades are displaced from the static electrical contact. The moveable electrical contact further comprises a reversible fixing means configured to removably couple at least a portion of the plurality of conductor blades to the moveable electrical contact in the second configuration. This may be advantageous for maintenance and replacement of individual conductor blades, for example in the case of corrosion. Replacement of individual conductor blades may reduce cost, time, and materials used compared to replacement of the entire moveable electrical contact.

In some examples, each conductor blade comprises a distal end and a proximal end. In the first configuration, the proximal end of each conductor plate is configured to abut the static electrical contact.

The DC disconnector may further comprise a base plate, wherein the reversible fixing means comprises a plurality of pivot fixings, wherein each pivot fixing is configured to reversibly couple the distal end of at least one conductor blade to the base plate. In some examples, removably coupling at least a portion of the plurality of conductor blades to the moveable electrical contact comprises removably coupling at least one pivot fixing from the base plate. In some examples, each pivot fixing is configured to couple two conductor blades to the base plate. In some examples, the pivot fixing is a hinge.

In some examples, the moveable electrical contact comprises a plurality of contact pressure modules, wherein each contact pressure module is configured to apply pressure to the moveable electrical contact to bias the conductor blades to contact the static electrical contact in the first configuration. Each contact pressure module may be coupled to the actuator arm and at least one conductor blade, wherein each contact pressure module is configured to apply pressure to said coupled conductor blade such that the conductor blade is biased to contact the static electrical contact in the first configuration. In some examples, each contact pressure module comprises a reversible fixing means (the second reversible fixing means of the DC disconnector) configured to removably couple at least a portion of the plurality of conductor blades to the moveable electrical contact by removably coupling at least a portion of the plurality of conductor blades to the actuator arm. In some examples the reversible fixing means of the contact pressure modules is configured to removably couple at least a portion of the plurality of conductor blades to the actuator bar of the moveable electrical contact. In some examples the reversible fixing means of the contact pressure module comprises, for example, a nut.

In a sixth aspect, there is provided a method for replacing at least part of a set of conductor blades in a DC disconnector comprising transitioning the DC disconnector of the fifth aspect into the second configuration, wherein the plurality of conductor blades are displaced from the static electrical contact, and uncoupling at least a first portion of the plurality of conductor blades to the moveable electrical contact by uncoupling at least a portion of the pivot fixings. In some examples, uncoupling the first portion of the plurality of conductor blades further comprises uncoupling at least a portion of the reversible securing means of the contact pressure modules. In some examples, the portion of the pivot fixings and the portion of the portion of the reversible securing means of the contact pressure modules correspond to the first portion of conductor blades. The method further comprises replacing the at least first portion of conductor blades with at least a second portion of replacement conductor blades and coupling the second portion of conductor blades to the moveable electrical contact by recoupling the portion of the pivot fixings. In some examples, coupling the second portion of conductor blades to the moveable electrical contact further comprises recoupling the reversible securing means of the contact pressure modules.

In some examples, the at least first portion and the at least second portion of conductor blades comprise the same number of conductor blades.

Whilst the first to sixth aspects of the invention are discussed above separately, the skilled person will understand the features of the first to sixth aspects may be combined, either in a selective combination, or all together to provide a DC disconnector comprising a plurality of features, including for example a plurality of contact elements of the first aspect, an eccentric component of the second aspect, a plurality of spacers of the third aspect, an adjustable shaft of the fourth aspect, and removable conductor blades of the fifth aspect.

The skilled person will understand that the features of each aspect are independent and may be integrated into a DC disconnector either separately, in combination, or all together. For example, a DC disconnector may comprise a plurality of spacers of the third aspect, and an adjustable shaft of the fourth aspect, but not a plurality of contact elements of the first aspect, an eccentric component of the second aspect, or removable conductor blades of the fifth. This example is intended to be purely illustrative, and all features of each aspect are interchangeable for use independently, in combination, or all together within a DC disconnector.

### BRIEF DESCRIPTION OF THE DRAWINGS

Embodiments of the disclosure will now be described, by way of example only, with reference to the accompanying drawings, in which:

FIG. 1 shows an example DC disconnector, in a first configuration.

FIG. 2 shows an example DC disconnector from a side view, in a first configuration, such as the disconnector shown in FIG. 1.

FIG. 3A shows an example DC disconnector in a first configuration, such as the disconnector shown in FIGS. 1 and 2. FIG. 3B shows an example DC disconnector in a second configuration, such as the disconnector shown in FIGS. 1, 2, and 3A.

FIG. 4A shows a cross section view of an example spacer module arrangement in a DC disconnector, such as the example DC disconnector shown in FIGS. 1 to 3. FIG. 4B shows a detailed view of a spacer, for example the spacer of FIG. 4A for use in a DC disconnector, for example the DC disconnector of FIGS. 1 to 3.

FIG. 5A shows an example contact element for use in a DC disconnector, for example the DC disconnector shown in FIGS. 1 to 4. FIG. 5B shows a plurality of contact elements, shown in FIG. 5A, coupled to a static electrical contact for use in a DC disconnector, for example the DC disconnector shown in FIGS. 1 to 4.

FIG. 6A shows an example actuator arm of a DC disconnector, for example the DC disconnector shown in FIGS. 1 to 5. FIG. 6B shows an eccentric component within the actuator arm of FIG. 6A, for example for use in the DC disconnector shown in FIGS. 1 to 5. FIG. 6B shows an example eccentric component, such as the eccentric component shown in FIG. 6A.

FIG. 7A shows an example support plate of a DC disconnector, for example the DC disconnector shown in FIGS. 1 to 5. FIG. 7A shows a cross-section view of an adjustable shaft and the support plate of FIG. 7A, for example in the DC Disconnector shown in FIGS. 1 to 6, wherein the position of the shaft is configured to be adjusted relative to the support plate.

FIG. 8 shows an example DC Disconnector, for example the DC Disconnector of FIGS. 1 to 7, in a third configuration, wherein at least a portion of the conductor blades may be removed from the Disconnector, and/or replaced, whilst in the third configuration.

FIG. 9 shows an example pivot fixing of a DC Disconnector, for example the DC Disconnector of FIGS. 1 to 8.

### DETAILED DESCRIPTION

In the context of the present disclosure other examples and variations of the apparatus and methods described herein will be apparent to a person of skill in the art.

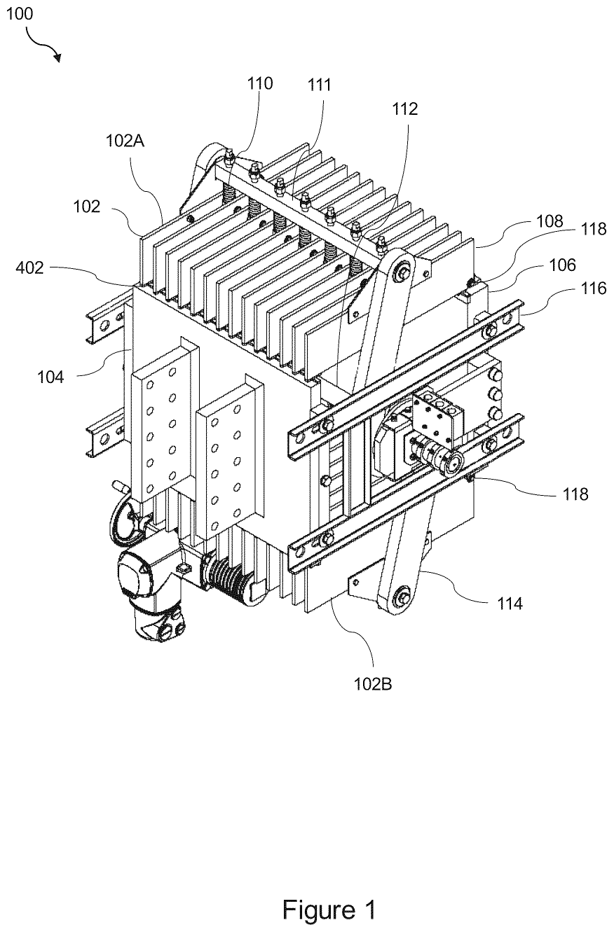

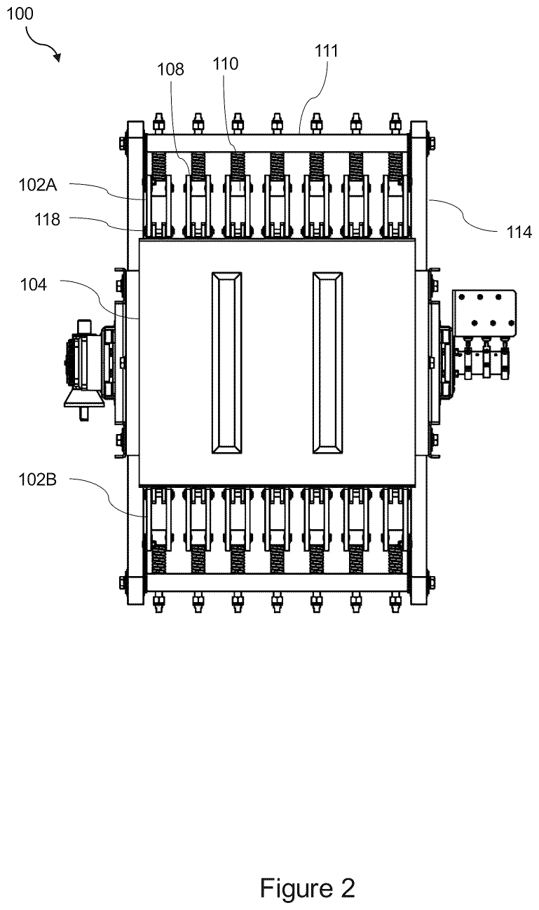

The example DC Disconnector 100 shown in FIG. 1 comprises a static electrical contact 104 and a base plate 106, wherein the base plate 106 is arranged opposite the static electrical contact 104. A pair of moveable electrical contacts 102A and 102B are coupled to opposite edges of the base plate 106 by respective pivot fixings 118. In the first configuration, as shown, the pair of moveable electrical contacts 102A and 102B are arranged to electrically couple the static electrical contact 104 and the base plate 106, by contacting opposite sides of the static electrical contact 104.

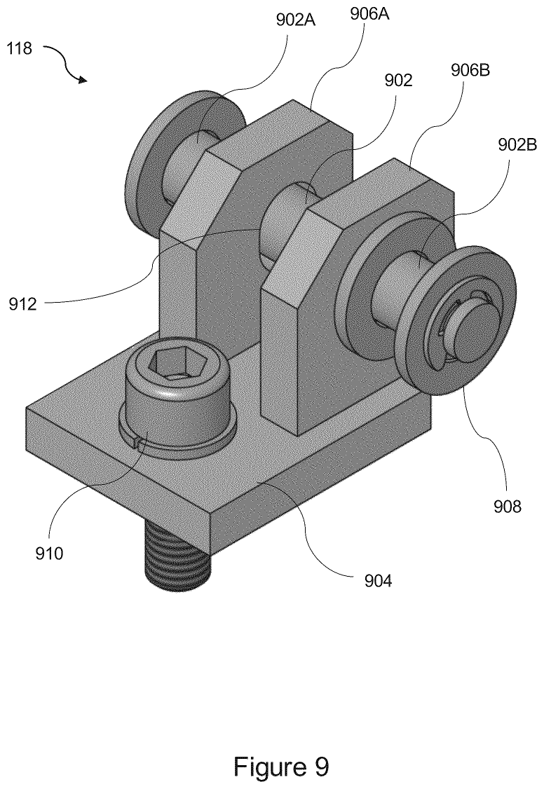

Each moveable electrical contact 102 comprises a plurality of conductor blades 108, wherein the plurality of conductor blades 108 are arranged adjacent to one another. Each conductor blade 108 is made of an electrically conductive material, preferably a highly electrically conductive material. In this example, the conductor blades 108 are made of copper. In the first configuration, each blade 108 is arranged to couple together the static electrical contact 104 and the base plate 106. Each conductor blade comprises a distal end and a proximal end. The distal end of each conductor blade 108 is coupled to the base plate 106 by a pivot fixing 118. An example pivot fixing is shown in more detail in FIG. 9. The proximal end of each conductor blade 108 comprises a contact engaging face portion 402. The contact engaging face portion 402 is made of an electrically conductive material, preferably a highly electrically conductive material. In this example, the contact engaging face portion 402 is made of silver. The contact engaging face portion 402 may protrude from the surface of the conductor blade 108. In this example, the contact engaging face portion 402 is 2 mm thick, however the skilled person will understand that other thicknesses and/or protrusion depths of the contact engaging face portion 402 may be used.

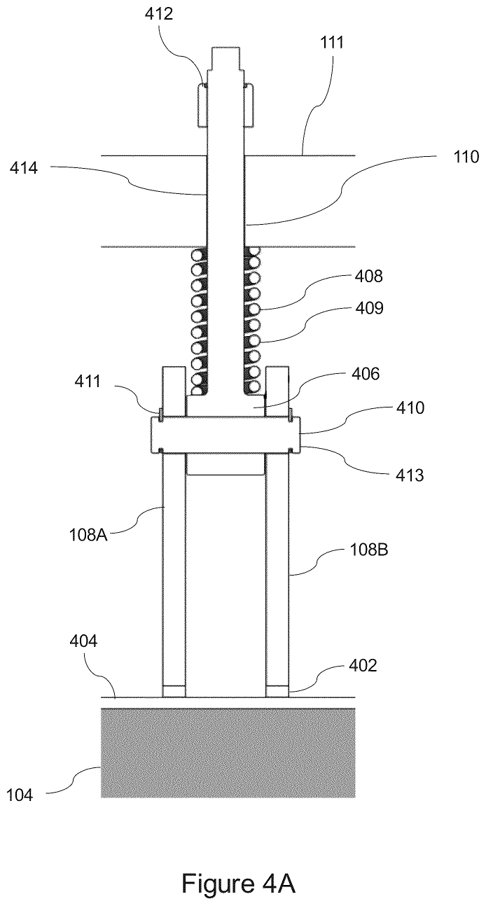

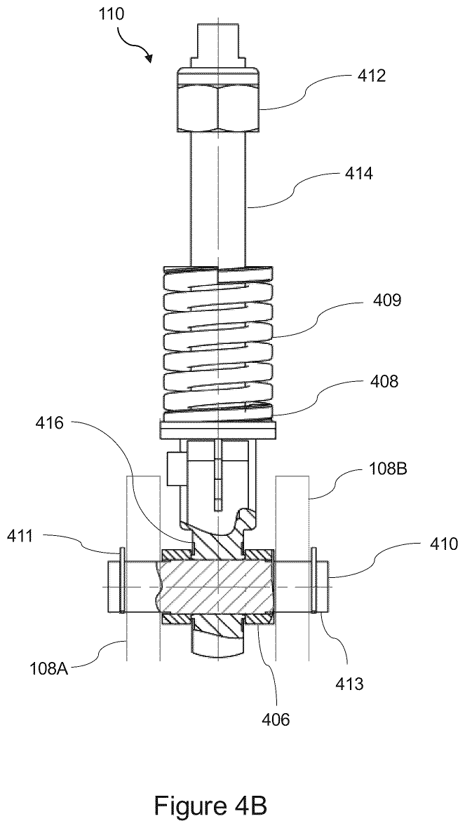

The plurality of conductor blades 108 for each moveable electrical contact 102 are coupled together by a plurality of spacers 110 coupled to an actuator bar 111 (or “drive bar”). In this example, at least a portion of each spacer 110 is arranged in between an adjacent pair of conductor blades 108. An example spacer 110 is shown in more detail in FIGS. 4A and B.

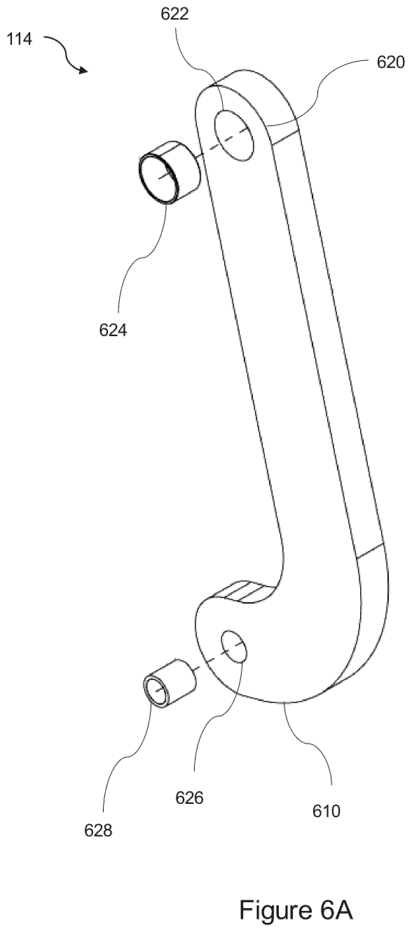

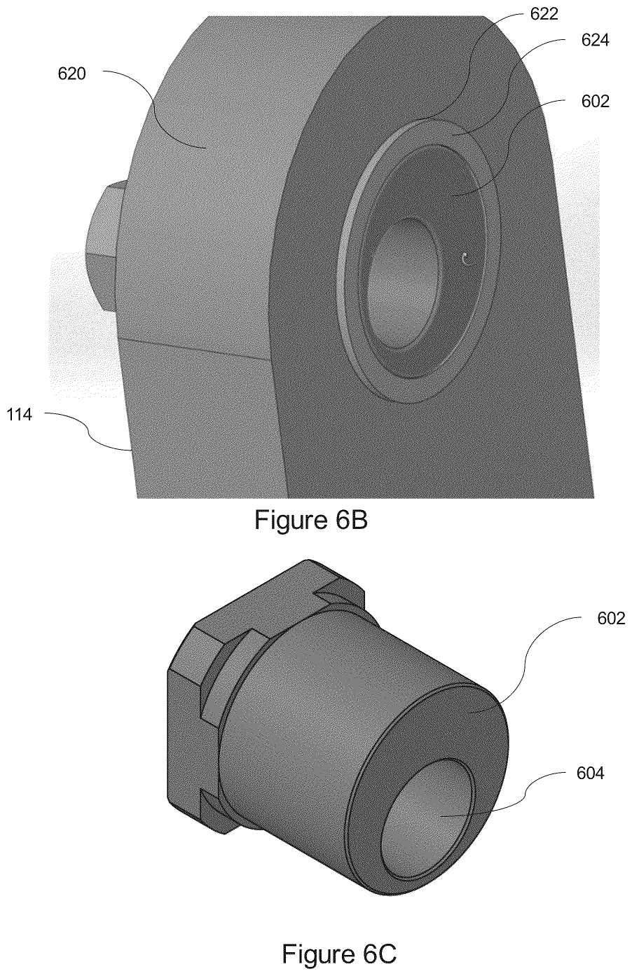

The DC Disconnector 100 further comprises a shaft 112, wherein the shaft 112 is coupled to the pair of the moveable electrical contacts 102A and 102B. In this example, each moveable electrical contact 102 is coupled to the shaft 112 by a pair of actuator arms 114. An example actuator arm is shown in more detail in FIG. 6A. Each pair of actuator arms 114 is arranged at opposite ends of their respective moveable electrical contact 102. The actuator bar 111 is coupled between the pair of actuator arms 114 via a bearing.

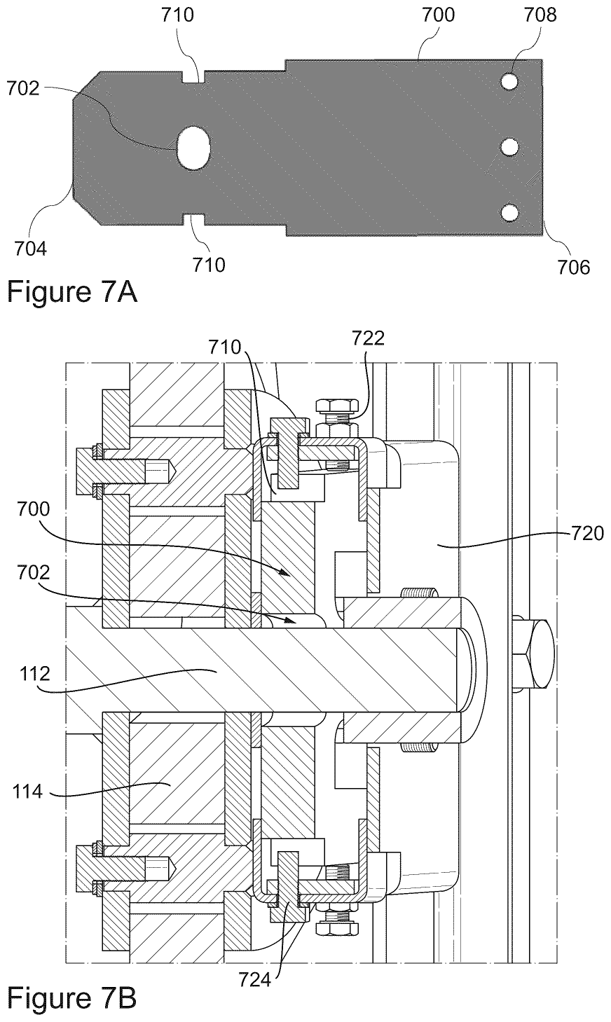

The shaft 112 is arranged in between the static electrical contact 104 and the base plate 106, such that the longitudinal axis of the shaft 112 is arranged parallel to the opposite faces of the static electrical contact 104 and the base plate 106. The shaft 112 is supported between the static electrical contact 104 and the base plate 106 by a support plate 700, wherein the support plate 700 is coupled to the base plate 106. An example support plate is shown in more detail in FIGS. 7A and 7B.

The static electrical contact 104 and the base plate 106 are coupled to a support frame 116. In this example, the support frame 116 is an ‘H-shape’ frame. The support frame 116 is electrically insulated from the static electrical contact 104 and the base plate 106.

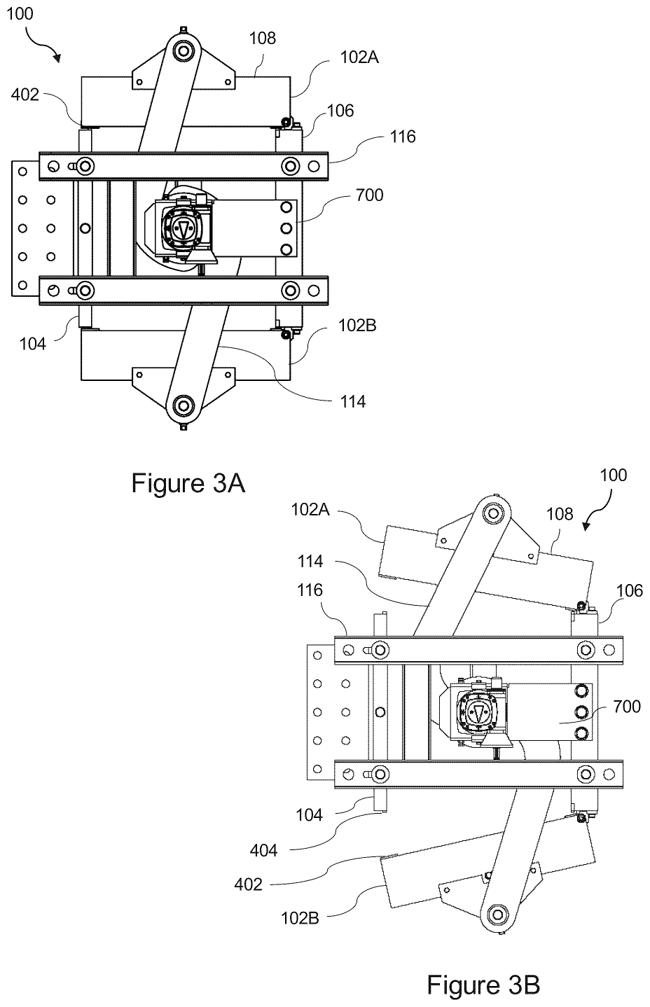

The shaft 112 is configured to rotate to actuate the actuator arms 114 to drive the pair moveable electrical contacts 102A and 102B to pivot in opposite directions. The actuator arms 114 are configured to actuate the moveable electrical contacts 102A and 102B between a first configuration and a second configuration by applying a vertical force component and a horizontal force component to the moveable electrical contacts 102A and 102B during rotation of the shaft 112. The movable electrical contacts 102A and 102B abut the static electrical contact 104 in the first configuration such that the contacting engaging face portion 402 of each conductor blade 108 is configured to contact the static electrical contact 104 in the first configuration, and the moveable electrical contacts 102A and 102B are displaced from the static electrical contact 104 in the second configuration. An example first configuration and second configuration are shown in more detail in FIGS. 3A and 3B respectively.

At least a portion of each conductor blade 108 is configured to contact the static electrical contact 104 in the first configuration. The portion configured to contact the static electrical contact 104 in the first configuration may comprise a contact strip 402.

The pair of moveable electrical contacts 102A and 102B are configured to pivot about the pivot fixing 118 between each moveable electrical contact 102A and 102B and the base plate 106.

Each of the plurality of spacers 110 is configured to align the adjacent pair of conductor blades 110 in a parallel configuration.

The support frame 116 is configured to maintain the spacing between the static electrical contact 104 and the base plate 106.

Starting from the second configuration, rotation of the shaft 112 actuates the actuator arms 114 such that the actuator arms apply a vertical force component and a horizontal force component to the moveable electrical contacts 102A and 102B via the actuator bar 111. This causes the moveable electrical contacts 102A and 102B, comprising the plurality of conductor blades 110, to pivot about the pivot fixing 118 until the plurality of conductor blades 110 contact the static electrical contact 104 in the first configuration. In the first configuration, an electrical connection/pathway is formed between the static electrical contact and the moveable electrical contact, and the disconnector is “on”.

Rotation of the shaft 112 in the other direction would return the disconnector to the second configuration. In the second configuration, displacement of the moveable electrical contacts 102 breaks the electrical connection and the disconnector is “off”.

In the example discussed above, the DC disconnector 100 comprises a pair of movable electrical contacts 102A and 102B. However, the skilled person will understand that in other examples, a single moveable electrical contact may be used, wherein the movable electrical contact is configured to abut the static electrical contact 104 in the first configuration, such that the disconnector is “on”, and wherein the moveable electrical contact is displaced from the static electrical contact 104 in the second configuration, such that the electrical connection is broken and the disconnector is “off”.

In use, the static electrical contact 104 may be coupled to a first busbar, for example an aluminium or copper busbar. The base plate 106 may be coupled to a second busbar, for example an aluminium or copper busbar.

FIG. 2 shows the example DC disconnector 100 shown in FIG. 1 from a side view, in the first configuration. This shows the parallel arrangement of the plurality of conductor blades 108. In this example, the DC disconnector 100 has fourteen conductor blades 108 arranged on each side of the static electrical contact 104. The plurality of conductor blades 108 are arranged into adjacent pairs and coupled by a spacer 110, an example pair of conductor blades 108 and spacer arrangement 110 is shown in more detail in FIG. 4A.

FIG. 3A shows the DC Disconnector 100 of FIGS. 1 and 2 in the first configuration from an end view. The contact engaging face portions 402 of the plurality of conductor blades are in electrical contact with the static electrical contact 104. Thus, the Disconnector is in the “on” or “closed” position.

Comparatively, FIG. 3B shows the DC Disconnector 100 of FIGS. 1 to 3A in the second configuration. The contact engaging face portion 402 of each conductor blade 108 is displaced from the static electrical contact 104. Thus, the Disconnector is in the “off” or “open” position.

In use, the plurality of conductor plates 108 are pivoted between the first and second configurations around the pivot fixings 118 coupled to the base plate 106. The movement is driven by the actuator arms 114 which are actuated by rotation of the shaft 112.

FIG. 4A shows a cross section view of an example spacer 110 arranged in between a pair of adjacent conductor blades 108A and 108B. The spacer 110 comprises a spacer head 406 and a coupling means 410. The spacer head 406 is arranged in between the pair of conductor blades 108A and 108B. The coupling means 410 is arranged to couple together each of the pair of conductor blades 108A and 108B and the spacer head 406. An example spacer 110 is shown in more detail in FIG. 4B, wherein the coupling means 410 comprises a bar 413 configured to be received by an aperture in the spacer head 406 and protrude from opposite sides of the spacer head 406. The coupling means further comprises a flange 411 on each end of the bar 413.

The spacer 110 is mounted to the actuator bar 111, such that the conductor blades 108A and 108B are coupled to the actuator bar 111 via the spacer 110. In this example, the spacer 110 further comprises a longitudinal member 414, wherein the longitudinal member 414 passes through an aperture in the actuator bar 111.

The spacer 110 further comprises a contact pressure module 408. In this example, the contact pressure module 408 comprises a spring 409. In this example, the spring 409 is arranged over the longitudinal member 414 and between the actuator bar 111 and the spacer head 406. The contact pressure module 408 further comprises a fastening means 412, wherein the fastening means is coupled to the longitudinal member 414 and is arranged on the opposite side of the actuator bar 111 to the spring 409. In this example the fastening means 412 is a nut.

Optionally, as shown in FIG. 4B, the spacer 110 further comprises a bearing 416, for example a rod end bearing, for example a spherical rod end bearing, wherein the bearing 416 couples together the contact pressure module 408 and the coupling means 410.

The spacer head 406 is configured to align the pair of conductor blades 108A and 108B in a parallel configuration. For example, each spacer 110 is configured to align the longitudinal axes of the plurality of conductor blades 108A and 108B in a parallel configuration, wherein the longitudinal axes of the plurality of conductor blades 108A and 108B are perpendicular to the rotational axis of the shaft 112. The spacer head 406 is also configured to maintain a fixed separation distance between the pair of adjacent conductor blades 108A and 108B.

The spacer 110 is further configured to couple together the pair of adjacent conductor blades 108A and 108B, for example via the coupling means 410, wherein the coupling means 410 is configured to couple together each of the pair of conductor blades 108A and 108B to opposite sides of the spacer head 406. The protruding ends of the bar 413 of the coupling means 410 are configured to be received by apertures in the pair of conductor blades 108A and 108B. The flanges 411 at each end of the bar 413 are configured to secure the position of the conductor blades 108A and 108B and the spacer 110 by being arranged on the opposite side of each conductor blade 108 to the spacer head 406.

The contact pressure module 408 is configured to apply a biasing pressure to at least the pair of adjacent conductor blades 108A and 108B such that the conductor blades 108A and 108B are mechanically biased to contact the static electrical contact 104 in the first configuration, as shown in FIG. 4A. In this example, the spring 409 is configured to engage with the actuator bar 111 and the pair of adjacent conductor blades 108A and 108B such that the compression of the spring is configured apply a biasing pressure to the pair of adjacent conductor blades 108A and 108B, biasing them away from the actuator bar 111.

The contact pressure module 408 is further configured to be adjustable to adjust the biasing pressure applied to the conductor blades. In this example, the tension and/or compression of the spring 409 is configured to be adjusted by adjusting the spacing between the actuator bar 111 and the conductor blades 108A and 108B, via adjusting the spacing between the actuator bar 111 and the spacer head 406. The fastening means 412 is configured to be adjusted to adjustably secure the spacing between the actuator bar 111 and the spacer head 406.

The bearing 416, for example the rod end bearing, is configured to evenly distribute the applied load between the pair of adjacent conductor blades 108A and 108B.

In use, the fastening means 412 may be adjustably secured in position along the longitudinal member 414. Moving the fastening means 412 closer to the spacer head 406 increases the compression of the spring 409 such that a greater biasing pressure is applied to the pair of conductor blades 108A and 108B. The biasing pressure pushes the conductor blades 108A and 108B away from the actuator bar 111, biasing the conductor blades 108A and 108B into the static conductor plate 104 in the first configuration.

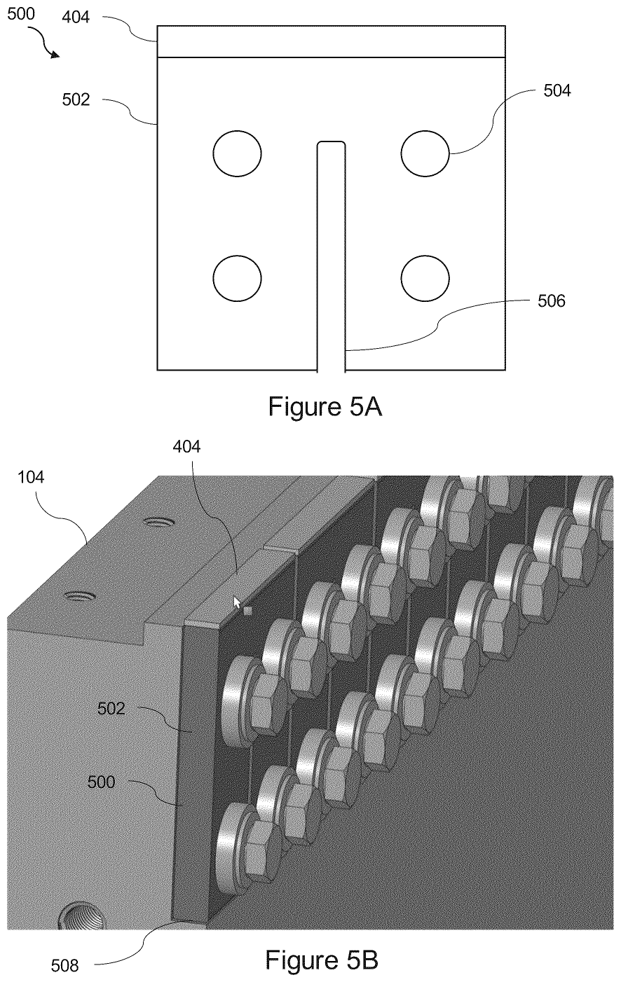

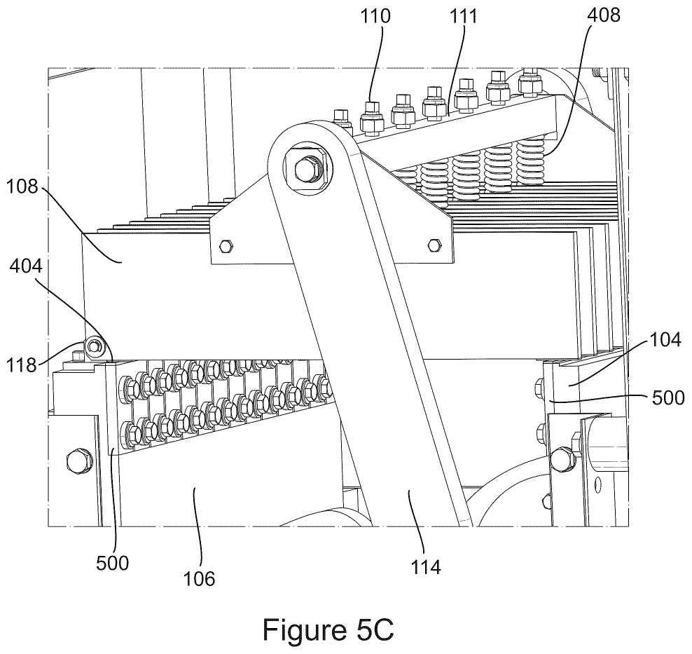

FIG. 5A shows an example contact element 500 for use in a DC Disconnector, for example the DC Disconnector 100 shown in FIGS. 1 to 4. The contact element 500 comprises a contact engaging face portion 404 and a connecting plate 502.

The connecting plate 502 comprises a cut-out portion 506. In this example, the cut-out portion 506 comprises a slot. In this example, the slot is substantially rectangular in shape and the longitudinal axis of the slot (parallel to the length of the rectangle) is perpendicular to the contact engaging face 404. The slot protrudes into the connecting plate 502 from the edge of the connecting plate 502 opposite the contact engaging face 404. In this example, the slot may have a length to width ratio of 20:1, for example wherein the slot is 80 mm long x 4 mm wide. However, the skilled person will understand that these measurements and ratio are merely one example and other ratios or measurements can be used.

The connecting plate 502 further comprises at least one aperture 504, in this example the connecting plate 502 comprises four apertures 504.

The contact engaging face portion 404 is made of an electrically conductive material, preferably a highly electrically conductive material. In this example, the contact engaging face is made of silver. The connecting portion 502 is also made of an electrically conductive material, in this example copper. The contact engaging face 402 may be bonded, welded, or brazed onto the connecting portion 502.

The contact engaging face portion 404 is configured to contact at least one conductor blade in the first configuration. The contact engaging face portion 404 is configured to protrude from an edge of the static electrical contact 104.

The connecting plate 502 is configured to couple the contact element to the static electrical contact 104.

The cut-out portion 506 of the connecting plate 502 is configured to accommodate deformation of the connecting plate 502, for example, including thermal expansion and contraction, deformation, and movement.

The connecting plate 502 is configured to be recessed into a receiving portion 508 of the static electrical contact 104, for example as shown in FIG. 5B. This may be advantageous for easy alignment and replacement during maintenance.

The apertures 504 are configured to receiving a coupling means, for example a bolt, wherein the coupling means is configured to couple the contact element 500 to the static electrical contact 104.

FIG. 5B shows a plurality of contact elements, shown in FIG. 5A, coupled to a static electrical contact 104 for use in a DC Disconnector, for example the DC Disconnector 100 shown in FIGS. 1 to 4. The plurality of contact elements 500 are spaced along opposite edges of the static electrical contact 104, however only one edge is shown in FIG. 5B. The contact engaging face portion 404 protrudes from the edge of the static electrical contact 104.

Optionally, a plurality of contact elements, for example the contact elements 500 of FIG. 5A may, additionally or instead, be coupled to the base plate 106 as shown in FIG. 5C for use in a DC Disconnector, for example the DC Disconnector 100 shown in FIGS. 1 to 5B. In this example, the plurality of connecting plates 502 are recessed and spaced along the edges of the base plate 106 to which the conductor blades 108 are coupled. The contact engaging face portion 404 protrudes from the edge of the base plate 106. In this example, in the first configuration, at least a portion of each conductor blade 108 is configured to abut at least one contact element 500 on the base plate 106. Each conductor blade 108 may thus be configured to form a two-point electrical connection in the first configuration, with (i) at least one contact element 500 on the base plate 106, and (ii) the static electrical contact 104, for example at least one contact element 500 on the static electrical contact 104. In the second configuration, the plurality of conductor blades 108 are displaced from all contact elements 500. In some examples, the number of contact elements coupled to the base plate 106 may be a function of current rating, for example wherein fewer contact elements 500 and/or conductor blades 108 may be required for a disconnector 100 with a lower current rating.

Alternatively, the plurality of contact elements 500 shown in FIG. 5B may comprise a single contact element. For example, wherein a single contact element may extend substantially across the entire length of an edge of the static electrical contact 104. In some examples, the single contact element may be the contact element 500 shown in FIG. 5A, comprising a contact engaging face portion 404 and a connecting plate 502, wherein the connecting plate 502 comprises a cut-out portion 506 configured to accommodate deformation of the connecting plate 502. The connecting plate may be recessed along an edge of the static electrical contact 104 such that the contact engaging face portion 404 protrudes from the edge of the static electrical contact 104. Similarly, a single contact element may extend substantially along the entire length of the opposite edge of the static electrical contact 104. In some examples, a single contact element, for example the contact element 500 of FIG. 5A may, additionally or instead, extend substantially along the entire length of one or two opposite edges of the base plate 106, for example equivalent to the embodiment shown in FIG. 5C, only wherein the plurality of contact elements 500 shown in FIG. 5C comprise a single contact element.

FIG. 6A shows an example actuator arm 114 for use in a DC Disconnector, for example the DC Disconnector 100 shown in FIGS. 1 to 5. The actuator arm 114 comprises a proximal end 610 and a distal end 620.

The proximal end 610 comprises a substantially curved portion, whereas the distal end comprises a substantially straight portion. In this example, the actuator arm 114 is substantially dog-legged in shape. The proximal end 610 comprises an aperture 626, and the distal end 620 also comprises an aperture 622.

The aperture 626 at the proximal end 610 of the actuator arm 114 is configured to receive the shaft 112 of a DC Disconnector. In this example, the aperture 626 at the proximal end 610 is configured to receive a bush 628, wherein the bush 628 is configured to receive the shaft 112.

The distal end 620 of the actuator arm 114 is configured to couple to a moveable electrical contact 102, for example wherein the actuator arm 114 is configured to couple to an actuator bar 111 comprising a plurality of conductor blades 108. In this example, the aperture 622 is configured to receive a bearing 624 wherein the bearing is configured to be coupled to an actuator bar 111.

The actuator arm 114 is configured to provide a vertical force component and a horizontal force component to the moveable electrical contact 102 during rotation of the shaft 112.

FIG. 6B shows the distal end 620 of an actuator arm 114, for example the actuator arm 114 of FIG. 6A, for example for use in the DC disconnector 100 of FIGS. 1 to 5. The aperture 622 comprises the bearing 624 and an eccentric component 602. The eccentric component 602 is shown in more detail in FIG. 6C.

The eccentric component 602 comprises an eccentric aperture 604 wherein the aperture is offset from the centre of the eccentric component 602 axis.

The eccentric aperture 604 is configured to receive the actuator bar 111.

The eccentric component 602 is configured to alter the distance between the plurality of conductor blades 108 and the static electrical contact 104 by altering the position of the actuator bar 111 within the actuator arm 114 by rotating the eccentric component 602 and, thus, altering the position of the eccentric aperture 604. In this example, the eccentric component 602 may be configured to alter the distance by approximately +/−5 mm, however the skilled person will appreciate different tolerances may be achieved, for example dependent on the size of the eccentric component 602 and the relative position of the eccentric aperture 604 within the component 602.

The rotated position of the eccentric component 602 is configured to be adjustably secured.

In use, altering the distance between the plurality of conductor blades 108 and the static electrical contact 104 by rotating the position of the eccentric component 602 is configured to adjust the contact pressure of the plurality of conductor blades 108 abutting the static electrical contact 104 in the first configuration. This may be advantageous to ensure good electrical connection between the plurality of conductor blades 108 and the static electrical contact. For example, this may be advantageous to compensate for the effects of gravity. For example, the contact pressure between the bottom moveable electrical contact 102B and the static electrical contact 104 in the first configuration may be less than the contact pressure between the top moveable electrical contact 102A and the static electrical contact 104 due to the effects of gravity. In this case, the eccentric component 602 of the bottom moveable contact 102B may be rotated to reduce the distance between the plurality of conductor blades 108 of the bottom moveable electrical contact 102B and the static electrical contact 104. As the horizontal and vertical force components provided by the actuator arm 114 remain unchanged, the resulting contact pressure between the bottom moveable electrical contact 102B and the static electrical contact 104 is relatively increased, improving the electrical connection.

FIG. 7A shows an example support plate 700. The support plate 700 comprises a proximal end 704 and a distal end 706, arranged at opposite ends of the length of the support plate 700. The proximal end 704 comprises a slot 702. The slot 702 is arranged such that the longitudinal axis of the slot 702 (parallel to the length of the slot 702) is perpendicular to the length of the support plate 700. In this example, the length of the slot 702 is 10 mm, however the skilled person will understand other lengths may be used. The height of the slot is dependent on the diameter of the shaft 112. The distal end 706 of the support plate 700 comprises a plurality of apertures 708, in this example, comprising three apertures 708.

The distal end 706 is configured to be coupled to the base plate 106 of a DC disconnector, for example the disconnector 100 of any of FIGS. 1 to 6. In this example, each aperture 708 is configured to receive a fixing means, for example a bolt, to couple the support plate 700 to the base plate 106.

The support plate 700 further comprises a pair of grooves 710. The grooves 710 are arranged on opposite edges of the support plate 710. In this example, the grooves 710 are aligned with the longitudinal axis of the slot 702, wherein the longitudinal axis of the slot 702 is parallel to the length of the slot 702.

The slot 702 is configured to receive the shaft 112, wherein the position of the shaft axis 112 within the slot 702 is configured to be adjustable. In this example, the position of the shaft axis 112 is configured to be adjusted within the length of the slot.

FIG. 7B shows a cross section view of the support plate 700 of FIG. 7A in use in a DC Disconnector, for example the DC Disconnector 100 of any of FIGS. 1 to 6. The assembly further comprises an adjustable securing means 720. In this example, the adjustable securing means 720 comprises at least a pair of pressure screws 722 arranged on opposite sides of the support plate 700. The adjustable securing means 720 further comprises a pair of tabs 724.

The adjustable securing means 720 is configured to adjust the position of the shaft 112 axis within the slot 702 of the support plate 700. The adjustable securing means 720 is configured to adjustably engage with the support plate 700 and the shaft 112, such that the position of the shaft 112 axis is reversibly secured to maintain the position of the shaft 112 axis within the slot 702 of the support plate 700. In this example, the position of the shaft 112 axis within the slot 702 of the support plate 700 is reversibly secured by adjusting the pressure screws 722 of the adjustable securing means 722 such that the pressure screws 722 apply a point force to the support plate 700 such that the adjustable securing means 722 is engaged to maintain the position of the shaft 112 axis relative to the position of the support plate 700. However, the skilled person will understand that any other suitable securing means configured to adjustably engage with the support plate 700 and the adjustable securing means 720 and/or shaft 112 may be used.

The pair of tabs 724 are configured to be received by the pair of grooves 710 of the support plate 700. The pair of tabs 724 are configured to maintain the position of the adjustable securing means 720 at a fixed displacement between the proximal end 704 and a distal end 706 of the support plate 700.

The longitudinal axis of the slot 702 (parallel to the length of the slot 702) is configured to be parallel to the opposite faces of the static electrical contact plate 104 and the base plate 106. Thus, the position of the shaft's 112 longitudinal axis is configured to be adjusted such that the position of the shaft axis 112 may be moved parallel to the static electrical contact plate 104 and the base plate 106. Thus, the position of the shaft axis 112 may be adjusted relative to the contact engaging face portions 404 on either side of the static electrical contact 104. In this example, the distance between the shaft axis 112 and the static electrical contact plate 104, and the shaft axis 112 and the base plate 106, is fixed as a result of the pair of tabs 724 of the adjustable securing means 720 within the grooves 710 of the support plate 700.

In use, adjusting the position of the shaft 112 axis within the slot 702 of the support plate 700 adjusts the position of the moveable electrical contacts 108 relative to the position of the static electrical contact 104. In this example, the position of the shaft axis may be altered by approximately +/−10 mm, based on the length of the slot. However, the skilled person will understand that this is merely an example, and the maximum alteration distance may be dependent on the size of the slot 702 within the support plate 700.

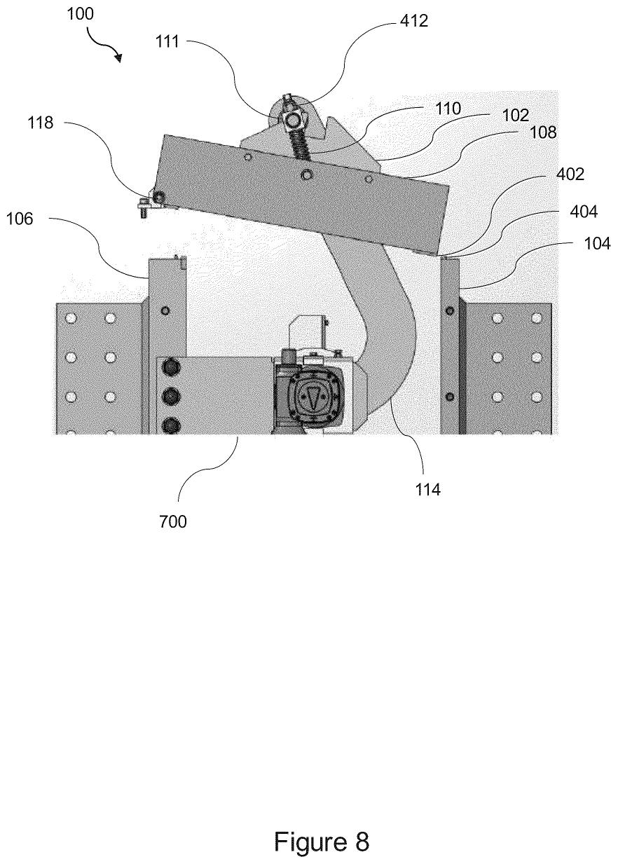

FIG. 8 shows an example DC Disconnector, for example the DC Disconnector 100 of FIGS. 1 to 7, in a third configuration, wherein at least a portion of the conductor blades are configured to be removed from the Disconnector, and/or replaced, whilst in the third configuration.

In this example, each pivot fixing 118 is a reversible fixing means. An example pivot fixing 118 is shown in more detail in FIG. 9. The pivot fixings 118 are configured to reversibly couple the distal end of the plurality of conductor blades 108 to the moveable electrical contact 102. In this example, each pivot fixing 118 couples two conductor blades 108 to the base plate 106. In this example, each pivot fixing 118 is a hinge.

In the third configuration, as shown in FIG. 8, the disconnector 100 is actuated into the second configuration, for example as shown in FIG. 3B. The plurality of pivot fixings 118 are then uncoupled from the base plate 106. This allows the moveable electrical contact 102 to pivot into the third configuration as shown in FIG. 8.

To remove at least a portion of the conductor blades 108, the fastening means 412 (the second reversible fixing means), in this example a nut, may be removed from the corresponding portion of spacer modules 110. The removal of the fastening means 412 then allows the longitudinal member 414 of each unfastened spacer module 110 to be removed through the aperture in the actuator bar 111, such that the pair of adjacent contact blades 108 associated with each unfastened spacer module 110 is removed from the moveable electrical contact 102, and disconnector 100 as a whole.

The removed conductor blades 108 may then be easily serviced or repaired and replaced. Alternatively, the portion of removed conductor blades 108 may be replaced with a second set of replacement conductor blades. The replacement conductor blades may be identical to the removed conductor blades, both in specification and in number.

The replacement conductor blade pairs may then be recoupled to the disconnector 100 by threading the longitudinal member 414 of the spacer module 110 through a corresponding aperture in the actuator bar 111 and fastening the fastening means 412. The distal end of each conductor blade 108 may then be recoupled to the base plate 106 by refastening the plurality of pivot fixings 118 to the base plate 106. The disconnector 100 is then restored to operation, in the second configuration.

The removal of the conductor blades 108 in this example is discussed in relation to a DC Disconnector comprising a spacer module 110, for example the spacer 110 shown in FIGS. 4A and 4B. However, the skilled person will understand that this method may also apply to other example disconnectors which do not comprise a plurality of spacer heads 406 and/or spacer modules, wherein the contact pressure module 408 is instead coupled to the edge of an adjacent pair of conductor blades. In these examples, to remove at least a portion of the conductor blades 108, the fastening means 412, in this example a nut, may be removed from the corresponding portion of contact pressure modules. The removal of the fastening means 412 then allows each unfastened contact pressure module to be removed through the aperture in the actuator bar 111, such that the pair of adjacent contact blades 108 associated with each unfastened contact pressure module is removed from the moveable electrical contact 102, and disconnector 100 as a whole.

FIG. 9 shows an example pivot fixing 118 of a DC Disconnector, for example the DC Disconnector 100 of FIGS. 1 to 8. In this example, the pivot fixing is a type of hinge. The pivot fixing 118 comprises a pin 902, wherein the pin comprises a distal end 902A and a proximal end 902B. The distal and proximal ends 902A and 902B of the pin 902 each further comprise a flange 908.

Rather than a conventional hinge “knuckle” or “barrel”, the pivot fixing 118 of FIG. 9 comprises a pair of pin supports 906A and 906B, wherein the pin supports 906A and 906B comprise an aperture 912.

The pivot fixing further comprises an attachment plate 904 comprising an aperture.

The distal end 902A of the pin is configured to receive a first conductor blade 108, and the distal end 902B of the pin is configured to receive a second conductor blade 108. Each flange 908 is configured to secure the position of the adjacent conductor blade 108 to the pivot fixing 118 by being arranged on the opposite side of the conductor blade 108 to the pin support 906.

The pin supports 906A and 906B are configured to support the pin 902 and provide a pivot point for pin 902. The pin 902 is configured to be received by the aperture 912 in each pin support 906A and 906B. Compared to a conventional “knuckle” or “barrel” configuration, the pin support configuration may be advantageous to de-load the pressure on the hinge and/or distribute the contact load or contact pressure provided by the shared contact pressure module between the pair of conductor blades 108.

The attachment plate 904 is configured to attach to the base plate 106. In this example, the attachment plate aperture is configured to receive a screw or bolt 910, wherein the screw or bolt 910 is configured to attach to the base plate 106. The screw or bolt 910 may advantageously be a reversible coupling such that the pivot fixing 118 may be reversibly coupled to the base plate 106.

In the example discussed above, the DC Disconnector 100 comprises a plurality of features, including for example a plurality of contact elements 500, an eccentric component 602, a plurality of spacers 110, an adjustable shaft 112, and removable conductor blades 108. However, the skilled person will understand that each of these features are independent and may be integrated into a DC Disconnector either separately, in combination, or all together. For example, a DC Disconnector may comprise a plurality of contact elements, for example the contact elements 500 of FIGS. 5A and 5B, but not an eccentric component, a plurality of spacers, an adjustable shaft, or removable conductor blades. Similarly, a DC Disconnector may comprise a plurality of spacers, for example the spacer 110 of FIGS. 4A and 4B, and an adjustable shaft 112, for example comprising a support plate 700 as seen in FIGS. 7A and 7B, but not a plurality of contact elements, an eccentric component, or removable conductor blades. These examples are intended to be purely illustrative, and all features are interchangeable for use independently, in combination, or all together within a DC Disconnector.

1. A DC disconnector comprising:
a static electrical contact, comprising a plurality of contact elements, wherein each contact element may be individually and reversibly coupled to the static electrical contact;
at least one moveable electrical contact, comprising a plurality of conductor blades; and
a shaft, coupled to the movable electrical contact, wherein the shaft is configured to actuate the moveable electrical contact between a first configuration and a second configuration, wherein at least a portion of each of the plurality of conductor blades abuts at least one contact element in the first configuration, and wherein the plurality of conductor blades are displaced from the contact elements in the second configuration.

2. The DC disconnector of claim 1, wherein at least a portion of each contact element is arranged in a recess of the static electrical contact.

3. The DC disconnector of claim 1, wherein each contact element comprises:
a contact engaging face configured to contact at least one conductor blade in the first configuration; and
a connecting plate configured to couple the contact element to the static electrical contact.

4. The DC disconnector of claim 3, wherein each connecting plate comprises a cut-out portion, wherein the cut-out portion is configured to accommodate deformation of the connecting plate.

5. The DC disconnector of claim 1, wherein the plurality of contact elements are spaced along at least one edge of the static electrical contact.

6. A DC disconnector comprising:
a static electrical contact;
at least one moveable electrical contact, comprising a plurality of conductor blades; and
a shaft, coupled to the at least one movable electrical contact, wherein the shaft is configured to actuate the moveable electrical contact between a first configuration and a second configuration, wherein at least a portion of each of the plurality of conductor blades abuts the static electrical contact in the first configuration, and wherein the plurality of conductor blades are displaced from the static electrical contact in the second configuration;
wherein the moveable electrical contact is coupled to the shaft using an eccentric component, wherein the eccentric component is configured to adjust the contact pressure of at least a portion of the plurality of conductor blades abutting the static electrical contact in the first configuration by rotating the eccentric component, and wherein the rotated position of the eccentric component is configured to be adjustably secured.

7. The DC disconnector of claim 6, wherein the eccentric component is configured to alter the contact pressure by altering the distance between the plurality of conductor blades and the static electrical contact.

8. The DC disconnector of claim 6, wherein the moveable electrical contact is coupled to the shaft via at least one actuator arm, wherein the actuator arm is configured to actuate the moveable electrical contact between the first configuration and the second configuration by applying a vertical force component and a horizontal force component to the moveable electrical contact during rotation of the shaft; and wherein the actuator arm is coupled to the plurality of conductor blades via the eccentric component.

9. A DC disconnector comprising:
a static electrical contact;
at least one a moveable electrical contact; and
a shaft, coupled to the at least one movable electrical contact, wherein the shaft is configured to actuate the at least one moveable electrical contact between a first configuration and a second configuration, wherein the movable electrical contact abuts the static electrical contact in the first configuration, and wherein the moveable electrical contact is displaced from the static electrical contact in the second configuration;
wherein the moveable electrical contact comprises:
a plurality of conductor blades, arranged adjacent to one another, wherein at least a portion of each conductor blade is configured to contact the static electrical contact in the first configuration; and
a plurality of spacers, wherein each of the plurality of spacers is arranged in between a pair of adjacent conductor blades, configured to align the pair of conductor blades in a parallel configuration.

10. The DC disconnector of claim 9, wherein each spacer is configured to couple said corresponding pair of adjacent conductor blades together.

11. The DC disconnector of claim 9, wherein the plurality of spacers are coupled to an actuator bar, such that the plurality of conductor blades are coupled to the actuator bar via the plurality of spacers, and wherein the actuator bar is coupled to the shaft via at least one actuator arm, such that the actuator arm coupled to the actuator bar is configured to actuate the plurality of conductor blades between the first configuration and the second configuration.

12. The DC disconnector of claim 9, wherein each spacer comprises a contact pressure module, wherein the contact pressure module is configured to apply a biasing pressure to at least the pair of adjacent conductor blades such that the conductor blades are mechanically biased to contact the static electrical contact in the first configuration.

13. The DC disconnector of claim 12, wherein each contact pressure module is configured to be adjustable to adjust the biasing pressure applied to the conductor blades.

14. The DC disconnector of claim 9, wherein each spacer further comprises:
a spacer head, wherein the spacer head is configured to be arranged in between the pair of adjacent conductor blades, and wherein the spacer head is configured to have the same width as the spacing between the pair of adjacent conductor blades; and
a coupling means, wherein the coupling means is configured to couple together each of the pair of adjacent conductor blades to opposite sides of the spacer head.

15. The DC disconnector of claim 9, wherein the plurality of spacers are configured to align the longitudinal axes of the plurality of conductor blades in a parallel configuration, wherein the longitudinal axes of the plurality of conductor blades are perpendicular to the axis of the shaft.

16.-28. (canceled)
